(19) United States
(12) Patent Application Publication
(10) Pub. No.: US 2017/0266759 A1
(43) Pub. Date: Sep. 21, 2017

(54) METHOD AND DEVICE FOR THE GENERATIVE PRODUCTION OF A THREE-DIMENSIONAL COMPONENT

(71) Applicants: Jacob Fieret, Orpington (GB); Pierre Foret, Munchen (DE); Ernst Miklos, Kirchheim (DE); Jürgen Scholz, Munchen (DE)

(72) Inventors: Jacob Fieret, Orpington (GB); Pierre Foret, Munchen (DE); Ernst Miklos, Kirchheim (DE); Jürgen Scholz, Munchen (DE)

(21) Appl. No.: 15/459,163

(22) Filed: Mar. 15, 2017

(30) Foreign Application Priority Data
Mar. 16, 2016 (EP) 16000641.7

(51) Int. Cl. B23K 26/12; B33Y 30/00; B23K 26/342; B33Y 10/00

(52) U.S. Cl. CPC B23K 26/123; B33Y 10/00; B33Y 30/00; B23K 26/342

(57) ABSTRACT

A method for the generative production of a three-dimensional component includes providing a metallic starting material in the form of a powder bed in a substantially horizontal starting plane, supplying a process gas to the starting material, melting the starting material by a heat source, repeating the above steps, wherein at least a portion of the process gas is supplied through the powder bed. A related device is also provided.

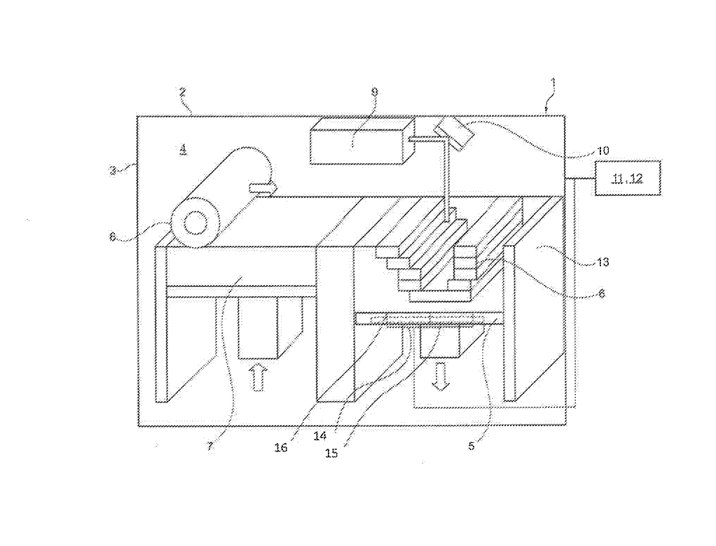

### BACKGROUND

The invention at hand relates to a method and a device for the generative production of a three-dimensional (3D) component.

By means of generative production methods, it is possible to produce a variety of three-dimensional components with a complex geometry.

In response to 3D printing, for example three-dimensional workpieces are constructed in layers. The construction is carried out in a computer-controlled manner from one or a plurality of liquid or solid materials according to specified dimensions and shapes (CAD). Physical or chemical hardening or melting processes occur in response to the construction. Typical materials for the 3D printing are plastics, synthetic resins, ceramics and metals. 3D printers are used in the industry and in research. In addition, there are also applications in the home and entertainment sector as well as in the art.

3D printing is a generative or additive production method, respectively. The most important techniques of 3D printing are the selective laser melting and the electron beam melting for metals and the selective laser sintering for polymers, ceramics and metals, the stereolithography and the digital light processing for liquid synthetic resins and the polymer modeling as well as the fused deposition modeling for plastics and partially synthetic resins.

A further generative method is the pointwise fusion and solidification. In the case of these types of methods, metal powder or metal wire is fused in layers and is solidified, so that a three-dimensional component can be generated. Due to the locally limited energy input by means of laser beam, the size of the formed melting bath is small. It is thus possible to generate filigree structures. Corresponding methods are commercially sold as laser engineered net shaping (LENS), as direct metal deposition (DMD), as laser additive manufacturing (LAM), as selective laser melting (SLM), as laser metal fusion (LMF) or as laser metal deposition (LMD).

In the case of the local laser sintering or melting, a distinction is made between indirect and direct methods.

Selective laser sintering (SLS) is a method for producing spatial structures from a starting material in powder form by means of sintering. Laser sintering is a generative layer construction method: the workpiece is constructed layer by layer. Due to the effect of the laser beams, any three-dimensional geometries can thus also be generated by means of undercuts, e.g. workpieces, which cannot be produced in conventional mechanical or casting production.

In the case of selective laser sintering (SLS/LMF), a layer of powder material is applied to a work surface (construction platform). The loose powder is fused pointwise by means of a laser beam. Depending on the material, which is used, the powder particles are thereby connected in the layer and to the layer located therebelow. Two basic development directions can be differentiated for the production of metallic components. In addition to the direct solidification of metallic powder materials by means of laser beam (direct metal laser sintering), the production of metallic components via a combination of SLS of plastic-coated metal powder with subsequent thermal treatment (IMLS) has already established itself early on.

In the case of direct metal laser sintering (DMLS), either one-component or multi-component metal materials are used. In particular, DMLS multi-component powders, which consist of different alloying elements, are used thereby. The low-melting component contained in the powder is fused by means of a laser beam and flows around the high-melting component, which serves as structurant.

In the case of electron beam melting (EBM), the process sequence substantially corresponds to that of the laser-based methods. Loose metal powder, in the powder bed or via a nozzle or wire, is thereby fused pointwise and solidifies subsequently in the desired contour. The energy required for this is introduced by means of an electron beam. The method mostly takes place in an inert gas-flooded low-pressure chamber.

In the case of generative production methods, a powder bed, a powder feeder or a wire feeder are used accordingly, wherein these starting materials are then fused or solidified subsequently by means of laser beam, electron beam, plasma/electric arc. In the case of the generative production methods, inert or active gases are furthermore used as process gases.

When using an inert gas atmosphere, the composition of the applied starting material substantially remains unchanged, after it has been fused by means of a heat source. The metallurgic properties as compared to the original material are changed by means of the fusion, solidification and heat impact zones.

The process gas atmosphere in the case of devices for the generative production, such as, e.g. in the case of laser metal fusion devices (LME), a cleaning is performed continuously by adding clean process gas, in order to keep contaminations below a permitted threshold value.

In the case of this known method above, a component to be constructed is furthermore covered gradually with metal powder, which has the result that heat, which cannot be removed by means of convection, is accumulated in the component.

LMF methods take place in a processing chamber, which is filled with a process gas. Typically, an inert gas is used thereby, in the case of which the contaminations must be strictly controlled. For example, the oxygen content must not exceed a certain threshold value of between 1 ppm and 1000 ppm. A further example for contaminations is the moisture, which is present in the processing chamber, which must also be strictly controlled. Further examples for contaminations are nitrogen, hydrogen, CO₂ and other gases.

When the processing chamber is opened to remove a produced component and to subsequently begin with the production of a new component, ambient air enters into the processing chamber. This ambient air must be removed by flushing the chamber with inert gas until an oxygen portion has dropped to a certain threshold value. The gas for flushing is introduced into the processing chamber via one or a plurality of gas inlets. The flushing of the chamber requires a relatively large amount of time, in particular if the threshold values of the contaminations are low.

Another source for contaminations is the powder itself, which can have contaminations on the surface of the particles absorbed, which are then released during the melting process and which thus contaminate the process gas atmosphere. A continuous cleaning process or flushing process, respectively, of the processing chamber thus takes place continuously, in order to keep the contaminations below a permitted threshold value.

The heat accumulation, which occurs in the component to be produced, is furthermore a limiting factor for the production process. At present, the heat, which accumulates in the component, is only removed by the thermal conductivity in the component to be constructed, because the heat transfer to the surrounding powder is very poor. The reason for this is that there is no real limit between the component to be constructed and the surrounding powder particles; the heat transfer to the surrounding particles is thus low, because the gas, which is present between the particles, has an isolation effect.

Due to the fact that the heat in the component to be constructed accumulates more and more, the process parameters change permanently during the production process and lead to different melting behaviors of the powder particles. This influences the geometry, the joining and the adhesion of the powder particles. The more heat accumulates in the component, the more process instabilities occur.

Changing heat conditions, in particular locally limited to the melting range as well as in the entire component, can have metallurgical consequences, which influence for example the grain size and the crystallization. Contaminations, which are present in the powder bed, such as, e.g., O₂ and H₂O etc., are released during the process.

### SUMMARY

It is thus the object of the invention is to provide an LMF method and a LMF device, in the case of which the processing chamber or the process gas atmosphere, respectively, can be freed from contaminations efficiently and easily and in particular more quickly.

A further object of the invention is to provide a LMF method and a LMF device, in the case of which the heat, which accumulates in the component, can be discharged more quickly and more efficiently.

These objects are solved by means of the embodiments specified in the claims.

According to the invention, provision is made for a method for the generative production of a three-dimensional component. This method includes the following steps: providing a metallic starting material in the form of a powder bed in a substantially horizontal starting plane, supplying a process gas to the starting material, melting the starting material by means of a heat source, and repeating the above steps.

The method according to the invention is characterized in that at least a portion of the process gas is supplied through the powder bed.

Due to the fact that the process gas is supplied in the area of the powder bed in a locally limited manner, the heat balance of the powder bed and/or of the component to be produced, can be controlled and/or the process gas atmosphere is cleaned, in particular in the area of the powder bed and/or of the particles of the metal powder.

A cooling of the component, which is arranged in the powder bed, is not possible with known devices. Due to the fact that the process gas is supplied in the area of the powder bed, the heat balance of the powder bed or of the component to be produced, respectively, can be controlled.

In the context of the invention, the term regulating the heat balance is understood to be a tempering of the powder bed or of the component to be produced, respectively, which comprises the cooling as well as the heating of the powder bed or of the component to be produced, respectively, by means of process gas.

The heat accumulated in the component can thus be efficiently removed.

A constant atmosphere in response to the generative production of the component is furthermore created at the uppermost layer of the component by means of the direct proximity of the area, in which the process gas enters into the processing chamber, to the powder bed.

The process parameters remain stable in this manner and homogenous metallurgical effects can be attained during the production.

By means of the method according to the invention, it is furthermore possible in a simple manner to keep the contaminations below an allowed threshold value in the case of devices for the generative production, such as, e.g. in the case of LMF devices, which use a powder bed, by means of adding clean process gas through the powder bed. By introducing clean gas, locally limited in the area of the powder bed, contaminations, which are present in the processing chamber and/or in the metal powder, such as, e.g., moisture, nitrogen, hydrogen, CO₂ and other gases, can quickly and efficiently be driven out of this area.

For supplying the process gas, provision can be made for a distribution device, which has a plurality of openings for applying process gas to the powder bed and via which process gas is applied to the powder bed, in particular in the area of the component to be produced.

The process gas can substantially flow vertically to the starting plane in the direction of the component to be produced.

Due to the fact that the gas flows upwards through the powder bed, an improved heat transfer from the component to be constructed is attained via forced convection.

The passage through the powder bed attained by means of the method according to the invention is attained by means of local excess pressure or by means of the gas injection, respectively, via the openings of the distribution device. When the process gas absorbs the heat from the component to be constructed or produced, respectively, the latter heats up and accelerates on its way to the top. This local acceleration increases the convection and ensures a quicker continuous flow or a quicker availability, respectively, of cold gas from underneath the powder bed.

When the gas leaves the powder bed, its temperature is higher than that of the remaining process atmosphere temperature. The continuous convection supports an efficient output of the process gas in an upper area of the processing chamber.

Provision is accordingly made according to the invention for the process gas to not only cool the powder bed and the component to be produced, but also removes contaminations from the process gas atmosphere and/or the powder.

It is advantageous in particular in the case of the method according to the invention that the cooling of the component allows for a quicker layer construction or quicker process rates, respectively. The course of the production process under stable thermal conditions in the powder bed has a positive impact with regard to the melting points, in which the laser beam hits the metal powder, improves the process stability and the reproducibility.

In addition, the constant temperatures in the work area of the laser beam are required for safely melting and locally connecting the metal powder particles.

Due to the fact that the metal powder contains fewer contaminations due to the locally limited application with process gas, components of higher quality and with less post-processing can be produced.

A further significant advantage of the invention is that turbulences or vortexing, respectively, in the processing chamber are avoided in that the gas is supplied underneath the powder bed or through the latter, respectively. In the case of devices, which are known from the prior art, such turbulences or vortexing, respectively, are created for the most part by the introduction of a gas flow above the powder bed.

The inventors of the invention also recognized that the powder bed, when applying a process gas to it from below, acts like a large diffuser, which avoids local vortexing. This also contributes to more stable process parameters and to a reproducible quality.

Prior to entering into the processing chamber, in which the component is produced, the process gas can be tempered by means of a tempering device.

The cooling effect can be increased by using gases or gas mixtures comprising an improved heat transfer and improved heat conducting properties.

The process gases, such as, e.g., Ar or N₂, mixed with He and/or H₂, which are typically used in the case of laser melting devices, can preferably be used for this purpose. Mixtures of Ar, N₂ as basis with He and/or H₂ and/or O₂ and/or CO₂ and/or silane and/or CO or N₂, are also possible, wherein the composition is a function of how the component is to be influenced via the process gas composition.

As process gas, provision can furthermore be made for pure helium or gas mixtures containing helium or H₂, for example.

The above-mentioned process gases better discharge the heat from the component and from the adjoining powder particles.

Due to the low viscosity of helium, the latter contributes, for example, to better remove contaminations, which are released by the metal powder, on the process gas atmosphere. H₂, for example, can be broken down locally and can react with atomic O₂ in the area of the component to be produced. Preventing the oxidation of the locally heated metal particles in the powder bed, also increases the ability or also facilitates the recycling of the metal powder.

Provision is furthermore made according to the invention for a device for the generative production of a component.

This device includes a horizontally arranged construction platform for accommodating the starting material, which is present in the form of a powder bed, a storage container for accommodating a solidifiable starting material in powder form, an application device for applying the starting material to the construction platform, a laser for generating a laser beam, and a process gas supply device.

The device according to the invention is characterized in that the construction platform includes a distribution device, which has a plurality of gas supply openings, for applying process gas from the process gas supply device to at least a partial area of the powder bed.

The advantages of the device according to the invention are substantially the same advantages, which have already been explained above with regard to the method according to the invention.

The gas supply openings can substantially run vertically to the starting planes in the direction of the component.

The distribution device can be a screen, a membrane-like structure, a perforated film, a sintered body or a nozzle plate, which form the gas supply openings.

Provision can furthermore be made for a process supply device, which has a storage container or process gas, which is connected to the distribution device via a line section.

The tempering device can have a nozzle for injecting a cooling medium, preferably a cryogenic medium, in a mixing chamber into the process gas.

The tempering device can also be a heat transfer device for cooling or heating the process gas.

The tempering device can also comprise cooling channels or heating elements, which are an integral part of the distribution device.

Provision can furthermore be made for a control device for controlling the tempering device. The control device can comprise a temperature control device comprising a closed control loop, which controls the temperature. By means of at least one temperature sensor, the temperature control device captures an actual value of a temperature of the process gas and/or of the process gas atmosphere and/or of the component and compares it to a predetermined setpoint value, wherein the predetermined setpoint value is adjusted via an actuator.

### BRIEF DESCRIPTION OF THE DRAWINGS

The invention will be explained in more detail below by means of a FIGURE.

The FIGURE shows a schematic illustration of a device according to the invention.

### DETAILED DESCRIPTION OF THE INVENTION

A device 1 for the generative production of a three-dimensional component will be described below. As already mentioned above, every device is on principle suitable for the generative production of three-dimensional components for carrying out the method according to the invention.

The device is a laser melting device 1. The laser melting device 1 comprises a process chamber 2, which is closed to the outside by means of a chamber wall 3 and which defines a processing room 4. The processing chamber 2 serves as assembly space for the three-dimensional component.

A container 13, which is open to the top, is arranged in the processing chamber 2. A construction platform 5 for accommodating the component 6 to be produced is arranged in the container 13. The construction platform 5 has a height-adjusting device (not illustrated), by means of which the construction platform 5 can be adjusted in vertical direction in such a way that a surface of a layer, which is to be solidified anew, is located in a working plane.

The construction platform 5 is embodied as a distribution device 14, which has a plurality of gas supply openings 16, for applying process gas to at least a partial area of the powder bed.

The gas supply openings 16 run substantially vertically to the starting plane in the direction of the component.

The distribution device 14 can be a screen, a membrane-like structure, a perforated film, a sintered body or a nozzle plate.

The device 1 furthermore comprises a storage container 7. The storage container 7 is embodied for accommodating a solidifiable starting material in powder form.

In addition, provision is made for an application device 8 for applying the starting material to the construction platform 5. Such an application device 8 can be moved parallel to the working plane in horizontal direction.

A laser 9 for generating a laser beam or a heat source, respectively, is arranged in the processing chamber 2. A laser beam generated by the laser 9 is deflected via a deflecting device 10 and is focused onto a predetermined point directly underneath the working plane by means of a focusing device (not illustrated). The course of the laser beam can be changed in such a manner by means of the deflecting device 10 that it fuses the spots of the applied layer, which correspond to the cross section of the object to be produced.

In addition, provision is made for a process gas supply device 11, by means of which a process gas can be applied to the processing chamber 2.

The process gas supply device 11 has a storage container for the process gas, wherein the process gas storage container (not illustrated) is connected to the distribution device 14 via a line section. In the alternative, the process gas storage container can be connected to the distribution device 14 and can be directly connected to the processing chamber via an inlet.

Provision is furthermore made for a tempering device 12.

The tempering device 12 for tempering the process gas is preferably integrated in this line section.

According to a first exemplary embodiment, the tempering device 12 has a heat transfer device or a heat exchanger device, respectively, by means of which the process gas can be tempered, before it enters the processing chamber.

According to a further exemplary embodiment, the tempering device 12 has a tempering chamber. Provision is made in the tempering chamber for at least one nozzle, which is connected to a storage container for a cryogenic medium in order to inject cryogenic medium into the tempering chamber in such a way that the process gas is cooled.

Cryogenic medium can thus be supplied to the tempering chamber via the nozzle. The process gas and thus the component to be produced in the processing chamber, can thus be cooled in this manner.

The tempering device 12 an also be embodied as a heat exchanger device.

Provision can furthermore be made in addition to or as an alternative for the above-described tempering device 12 for the distribution tempering device 15, which comprises cooling channels or heating elements, so that the distribution tempering device 15 is an integral part of the distribution device.

Provision can also be made for two tempering devices 12, so that an external tempering device (arranged outside of the processing chamber) and a tempering device is an integral part of the distribution device 14.

The tempering device 12 furthermore comprises a control device (not illustrated) for controlling the tempering device. The control device can comprise a temperature control device (not illustrated) comprising a closed control loop, which controls the temperature. The temperature control device can comprise a P-controller, an I-controller, a D-controller and combinations thereof, such as, e.g., a PID-controller. By means of at least one temperature sensor, the temperature control device captures an actual value of a temperature of the process gas and/or of the process gas atmosphere and/or of the component 6 and compares it to a predetermined setpoint value, wherein the predetermined setpoint value is adjusted via an actuator.

A method according to the invention will be described below by means of a first exemplary embodiment.

In the first step, a metallic starting material is thereby applied or provided, respectively, on the construction platform in the form of a powder bed by means of the coating device. In the alternative, the metallic starting material can also be supplied by means of a powder feeder or a wire feeder.

In a second step, the process gas is subsequently supplied to the tempering chamber of the tempering device from a process gas storage container.

In a next step, the process gas in then supplied to the powder bed or the processing chamber, respectively, via the distribution device. With regard to this, reference is made to the above-described advantages.

In a next step, the starting material is fused by means of the laser.

These steps are repeated.

The tempering is controlled by a control or temperature control device, respectively, wherein an actual value of a temperature of the process gas and/or of the process gas atmosphere and/or of the component is captured by means of at least one temperature sensor, is compared to a predetermined setpoint value and the predetermined setpoint value is adjusted via an actuator.

To reach the setpoint value, a cryogenic medium from a storage container for cryogenic medium is injected into the tempering chamber in an intermediate step as needed, and the process gas is cooled down in this manner.

The cooled process gas is then supplied to the processing chamber. The temperature of the component to be produced can be influenced by supplying the cooled process gas.

The temperature of the component can be optimally adjusted in this manner.

These steps are repeated until the component is completed.

Due to the fact that the metal powder contains fewer contaminations due to the locally limited application with process gas, components of higher quality and with less post-processing can be produced.

In addition, provision can be made for a stabilizing step, in which the layer is cooled down and solidified. For the most part, the solidification already takes place during the process at another location in the assembly space or when the next powder layer is applied.

1. A method for the generative production of a three-dimensional component comprising:
(a) providing a metallic starting material as a powder bed in a substantially horizontal starting plane;
(b) supplying a process gas to the starting material, wherein at least a portion of the process gas is supplied through the powder bed and said process gas is a gas selected from the group consisting of helium, hydrogen, and a mixture thereof;
(c) melting the starting material by means of a heat source;
(d) cooling and solidifying the starting material; and
(e) repeating steps (a)-(d) above.

2-13. (canceled)

14. The method of claim 1, wherein the supplying the process gas comprises applying the process gas from a distribution device to the powder bed in an area where the three-dimensional component is produced.

15. The method of claim 1, further comprising flowing the process gas substantially vertically to the horizontal starting plane in the direction of the three-dimensional component.

16. The method of claim 1, further comprising tempering the process gas before said process gas enters a process chamber in which the three-dimensional component is produced.

17. The method of claim 1, further comprising controlling a heat balance of the process gas by tempering said process gas, said tempering comprising a select one of heating the process gas, and cooling the process gas.

18. A device for the generative production of a component comprising:
a process chamber having a chamber wall for closing said process chamber from an exterior of the chamber wall;
a process gas supply device containing a process gas selected from the group consisting of helium, hydrogen, and a mixture thereof;
a horizontally arranged construction platform for accommodating starting material provided in a powder bed form, the construction platform comprising a distribution device including a plurality of gas supply openings for applying the process gas from the process gas supply device to at least a portion of the powder bed;
a storage container for accommodating the starting material, the starting material being solidifiable;
an application device for applying the starting material to the construction platform; and
a laser for generating a laser beam to the starting material.

19. The device of claim 18, wherein the plurality of the gas supply openings each are substantially vertical with respect to a direction of the component.

20. The device of claim 18, wherein the distribution device forms the plurality of gas supply openings and is selected from the group consisting of a screen, a membrane-like structure, a perforated film, a sintered body, and a nozzle plate.

21. The device of claim 18, further comprising a tempering device including a tempering chamber for tempering the process gas.

22. The device of claim 21, wherein the tempering chamber comprises at least one nozzle for injecting a heat transfer medium to the process gas, the heat transfer medium selected from the group consisting of a cooling medium, and a cryogenic medium; and the device further comprises a storage container for the heat transfer medium.

23. The device of claim 21, wherein the tempering device comprises a heat transfer device for selectively cooling and heating the process gas, the heat transfer device constructed and arranged for heat transfer selected from the group consisting of direct heat transfer, indirect heat transfer, and semi-indirect heat transfer.

24. The device of claim 18, wherein the distribution device comprises a distribution tempering device being integral with the distribution device and having at least one of cooling channels, and heating elements.

25. The device of claim 21, further comprising a control device for controlling the tempering device, the control device comprising a temperature control device including a closed control loop which controls the temperature of the process gas.
